(19) United States
(12) Patent Application Publication
(10) Pub. No.: US 2019/0270074 A1
(43) Pub. Date: Sep. 5, 2019

(54) METHOD FOR PRODUCING A CATALYST

(71) Applicant: RHODIA OPERATIONS, Paris (FR)

(72) Inventors: Thomas MATHIVET, La Chapelle de la Tour (FR); Chantal ROTILLON, La Rochelle (FR); Nicolas BARTHEL, Saint Rogatien (FR)

(73) Assignee: RHODIA OPERATIONS, Paris (FR)

(21) Appl. No.: 16/308,447

(22) PCT Filed: Jun. 6, 2017
(86) PCT No.: PCT/FR2017/051429

§ 371 Date: Dec. 7, 2018

(30) Foreign Application Priority Data
Jun. 9, 2016 (FR) 1655320

(51) Int. Cl. B01J 27/051; C01G 39/06; B01J 35/00; B01J 37/20; B01J 21/18; C07F 11/00

(52) U.S. Cl. CPC B01J 27/051; C01G 39/06; B01J 35/0013; C01P 2004/24; B01J 21/18; C07F 11/00; C01P 2004/64; B01J 37/20

(57) ABSTRACT

The present invention relates to the use of a molybdenum carboxylate as precursor of a catalyst based on molybdenum sulfide, and also to the process for preparing such a catalyst. The invention also relates to certain molybdenum carboxylates.

### TECHNICAL FIELD

The present invention relates to the use of a molybdenum carboxylate as precursor of a catalyst based on molybdenum sulfide, and also to the process for preparing such a catalyst. The invention also relates to certain molybdenum carboxylates.

### TECHNICAL PROBLEM

The technical context is that of hydroconversion in the presence of catalysts based on molybdenum sulfide. Industrial processes for hydroconversion of heavy feedstocks already exist. Mention may be made of the MRC process from Exxon which is carried out between 420° C. and 450° C. under a pressure of between 10 and 15 MPa or the SOC process from Asahi Chemicals which is carried out at a higher temperature, 475-480° C., under a higher pressure (20-22 MPa).

The EST process developed by ENI, which is a process for ebullating-bed hydroconversion of heavy feedstocks, makes it possible to achieve high conversions using catalyst recycling. The catalyst which is used in the EST process is in the form of well-dispersed particles of molybdenum sulfide which are obtained in situ from an oil-soluble molybdenum compound. The oil-soluble compound is introduced into the hydroconversion reactor at the same time as the feedstock to be treated. The catalytic activity of the catalyst is maintained despite the recycling.

Molybdenum 2-ethylhexanoate is an oil-soluble compound used as precursor in the preparation of a hydroconversion catalyst. However, the carboxylic acid 2-ethylhexanoic acid is classified in the family of CMR substances (CMR=carcinogenic, mutagenic, reprotoxic) by European authorities, such that the use of this oil-soluble compound is liable to pose a danger to the personnel who would have to handle it. The same applies to molybdenum naphthenates, also described as other precursors in the prior art. The molybdenum carboxylates described in the present application do not exhibit the same risk profile and can therefore be used as precursors in the preparation of a catalyst based on molybdenum sulfide.

### PRIOR ART

WO 2008/141831 describes a process for hydroconversion of a heavy feedstock using a catalyst based on molybdenum. Molybdenum octoate or 2-ethylhexanoate is used as catalyst precursor.

WO 2009/149923 describes a process for hydroconversion of a heavy feedstock using a catalyst based on molybdenum which is prepared from an oil-soluble molybdenum compound. The compound described is molybdenum 2-ethylhexanoate.

WO 2013/098741 describes a hydrotreatment process using a catalyst based on molybdenum prepared from an oil-soluble molybdenum compound which may be molybdenum 2-ethylhexanoate, naphthenate or hexanoate.

US 2013/0248422 describes a process for hydroconversion of a heavy feedstock using a molybdenum salt which may be 10-undecenoate, dodecanoate, 3-cyclo-pentylpropionate, cyclohexanebutyrate, 4-heptylbenzoate, 5-phenylvalerate or 3,7-dimethyl-2,6-octadienoate.

EP 0512778 describes a process for hydroconversion of a heavy feedstock using a molybdenum salt in combination with another salt of another metal, for example cobalt.

### DETAILED DESCRIPTION

The invention relates to the use of a molybdenum carboxylate selected from the group consisting of molybdenum neodecanoate, nonanoate, 3,5,5-trimethylhexanoate and iso-octadecanoate, as precursor of a catalyst based on molybdenum sulfide. The invention also relates to the use of said molybdenum carboxylate for preparing a catalyst based on molybdenum sulfide. The invention also relates to the use of said molybdenum carboxylate in a process for hydroconversion of a heavy feedstock.

In the carboxylate, the molybdenum may be present in the +VI oxidation state. The carboxylate may be one of those described in one of the examples.

In the present application, the molybdenum neodecanoate denotes the carboxylate prepared from the carboxylic acid or mixture of carboxylic acid(s) of formula (I):

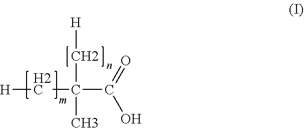

wherein n and m represent integers for which n+m equals 7. Formula (I) therefore comprises 10 carbon atoms in total.

An example of acid corresponding to formula (I) is the compound of formula:

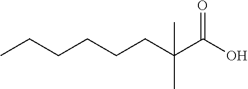

or else of formula:

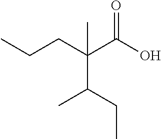

The acid or mixture of acids of formula (I) generally has an acid number according to standard ASTM D1980 of between 310 and 330 mg KOH/g, or even between 310 and 325 mg KOH/g or between 320 and 330 mg KOH/g. By way of examples of commercial acids according to formula (I), use may be made of the product branded Versatic Acid 10, sold by Hexion, or else the product branded Neo Decanoic Acid, sold by Exxon-Mobil.

The catalyst based on molybdenum sulfide may be used in a hydroconversion process, especially a process for the hydroconversion of a heavy feedstock. It may be a suspension process or an ebullating-bed process. The term “hydroconversion” denotes all processes in which a hydrocarbon-based feedstock reacts with hydrogen. Among the hydroconversion processes, mention may be made of hydrotreatment, which consists in reducing the content of certain impurities in a feedstock (N, S, O, metals). Mention may also be made of hydrocracking which consists in converting a heavy feedstock into a lighter feedstock. The molecules of the heavy feedstock are broken up so as to reduce their molecular weight and the H/C ratio of the feedstock increases. Heavy feedstock generally denotes a hydrocarbon-based feedstock, at least 80% by weight of which has a boiling point of greater than or equal to 340° C. The heavy feedstock may for example be a crude oil, a bitumen, a residue from atmospheric or vacuum distillation, a gas-oil fraction obtained under vacuum (VGO), a heavy oil, a deasphalted distillation residue, shale oil or else a feedstock resulting from biomass. The main function of the catalyst based on molybdenum sulfide is to activate the hydrogen and to promote the transfer of hydrogen from the gas phase to the feedstock to be treated. The catalyst based on molybdenum sulfide also has a function of eliminating impurities from the feedstock, especially reducing sulfur (hydrodesulfurization, HDS), reducing metals, especially Ni and V (hydrometallation, HDM), reducing nitrogen (hydrodenitrogenation, HDN) or else reducing oxygen (hydrodeoxygenation, HDO). It is thus possible to reduce respectively the concentration of the S, metals, N or O impurities contained in the feedstock to be treated.

The molybdenum carboxylate is used as precursor for a catalyst based on molybdenum sulfide, which means that the carboxylate is converted into molybdenum sulfide. The carboxylate→sulfide conversion is carried out in the presence of at least one sulfurizing agent and hydrogen. The conversion is carried out at high temperature, typically between 250° C. and 500° C., preferentially between 250° C. and 400° C. The hydrogen partial pressure is high, typically between 30 bar and 300 bar, preferentially between 50 and 200 bar. A sulfurizing agent is a chemical molecule containing one or more sulfur atom(s), the function of which is to convert an oxide to a sulfide. Following the conversion, the molybdenum sulfide may be entirely or partially present in the form of MoS₂ or in the form of a sulfide other than MoS₂. It is also not excluded for the sulfurization not to be complete, which means that after sulfurization the molybdenum sulfide is entirely or partially in the form of a molybdenum oxysulfide.

The sulfurizing agent may for example be hydrogen sulfide (H₂S) or an organic compound which may release H₂S. By way of example, the sulfurizing agent may be dimethyl disulfide (DMDS) which has a high sulfur content and is safe to use (low volatility, low inflammability and moderate toxicity). In the case of the in situ sulfurization described below, the organic sulfur-based compound which may release H₂S may be contained in the hydrocarbon-based feedstock to be treated itself.

The conversion of the molybdenum carboxylate into molybdenum sulfide may be carried out at any time during the process. It may be carried out before introducing the carboxylate into the hydroconversion reactor: reference is then made to pre-sulfurization or ex situ sulfurization. It may also be carried out right within the hydroconversion reactor: reference is then made to in situ sulfurization. The organic sulfur-based compound may already be present in the feedstock to be treated itself. It is also possible to add a sulfurizing agent (typically DMDS) to the hydrocarbon-based feedstock, since the sulfurizing agent releases H₂S at lower temperatures than the sulfur-containing compounds already present in the feedstock to be treated.

Examples of processes that may use the carboxylate according to the invention are those described in applications WO 2006/066911, EP 2148912, WO 2008/141831 or WO 2008/151792.

Examples of catalysts based on molybdenum sulfide will now be described more precisely. According to a first example, the molybdenum carboxylate makes it possible to prepare a catalyst based on molybdenum sulfide which is in the form of nanoparticles of MoS₂, especially in the form of sheets. The length of a sheet may preferably be less than or equal to 20 nm, more preferentially less than 10 nm. The MoS₂ may be in the form of stacks of less than 10 sheets, preferably of less than 5 sheets. The nanodisperse form of MoS₂ makes it possible to obtain high catalytic activity. The nanoparticles of MoS₂ may be suspended in the hydroconversion reactor or else dispersed at the surface of carbon-based particles, such as, for example, coke particles, present in the hydroconversion reactor. In the in situ preparation, the molybdenum carboxylate and a feedstock to be treated, especially a heavy feedstock, are introduced into a hydroconversion reactor, the conversion of the molybdenum carboxylate into molybdenum sulfide being carried out in the presence of at least one sulfurizing agent and hydrogen.

The molybdenum sulfide may be used as sole catalyst or be combined with one or more other catalyst(s). Thus, according to a second example, the molybdenum carboxylate makes it possible to prepare the molybdenum sulfide which acts in combination with a cracking catalyst which is in the form of micrometric or nanoscale particles. The micrometric particles of the cracking catalyst may have a size of less than 10 μm, or even less than 5 μm, or even less than 1 μm. The micrometric particles of the cracking catalyst may have a size of less than 10 nm, or even less than 5 nm, or even less than 1 nm.

The size of the particles may be the median value d50 determined by transmission electron microscopy (TEM): by observing several SEM micrographs, it is possible to obtain a distribution by number of the particle diameters. The distribution therefore represents the number of particles separated by classes, the width of the classes being adapted to the size of the particles and taking into account the maximum size. The number of classes is generally between 10 and 20. The number of particles in each category is the basic data for representing the distribution by number (cumulative). The diameter to be taken into account is that of the minimum enclosing circle which can circumscribe the entirety of the image of the particle as is visible on a TEM image. The term “minimum enclosing circle” has the meaning given to it in mathematics and represents the circle of minimum diameter which can contain a set of points on a plane. Only the particles for which at least half of the perimeter is defined are selected. The ImageJ software may be used to perform the processing more simply: this open-access software was initially developed by the American NIH institute and is available at the following address: http://rsb.info.nih.gov or http://rsb.info.nih.gov/ij/download.html.

The combination of the two catalysts, MoS₂ and cracking catalyst, may be used to improve the conversion of heavy feedstocks, especially in a suspended-bed or ebullating-bed reactor. The function of the cracking catalyst is to reduce the molecular weight of the molecules of the feedstock to be treated. The cracking catalyst is generally formed of a material having a Bronsted or Lewis acid function. By way of examples, this may be an amorphous aluminosilicate, especially a silica-alumina, a crystallized aluminosilicate, especially a zeolite, for example of HY, Y or beta type. The cracking catalyst may also be an ordered mesoporous material, especially of MCM type, for example MCM-22, or an acidified alumina, for example acidified by phosphorus. For this combination, the molybdenum sulfide may again be in the form of nanoparticles of MoS₂, as has been described above. The nanoparticles of MoS₂ may be suspended in the hydroconversion reactor and/or dispersed at the surface of carbon-based particles, such as, for example, coke particles, present in the hydroconversion reactor, and/or dispersed at the surface of the particles of cracking catalyst. In the in situ preparation, the molybdenum carboxylate, the cracking catalyst and a feedstock to be treated, especially a heavy feedstock, are introduced into the hydroconversion reactor, the conversion of the molybdenum carboxylate into molybdenum sulfide being carried out in the presence of at least one sulfurizing agent and hydrogen.

Within the context of the present invention, it is not excluded that the molybdenum in the molybdenum sulfide is combined with one or more other metal agent(s) selected from the group consisting of nickel, cobalt and tungsten. This combination makes it possible to improve the activity of the molybdenum. Such a combination may be produced by combining the molybdenum carboxylate with another precursor of the metal element(s) before introduction into the hydroconversion reactor.

According to a third example, the molybdenum carboxylate makes it possible to prepare a hydrotreatment catalyst composed of particles of a mineral material, on which a layer of molybdenum sulfide is partially or completely deposited. The mineral material may be a pure or doped alumina, especially of y crystallographic phase, an amorphous or crystalline aluminosilicate of zeolite type, especially a beta zeolite. The mineral material is preferably in the form of beads, granules or extrudates, the characteristic length and/or diameter of which are generally of the order of 0.5 to 6 mm. The layer of molybdenum sulfide preferably has a thickness ranging from 0.001 μm to 1.0 μm, or even from 0.01 μm to 0.1 μm. The catalyst may be prepared in situ by introducing the molybdenum carboxylate and the feedstock to be treated into a fixed-bed reactor containing the particles of the mineral material, the conversion of the molybdenum carboxylate into molybdenum sulfide being carried out in the presence of at least one sulfurizing agent and hydrogen. The operation making it possible to obtain the layer of molybdenum sulfide needs to be carried out in two steps: during a first step, the temperature within the reactor is sufficiently low to avoid the formation of molybdenum sulfide, which enables the carboxylate to adsorb on the surface of the mineral material without decomposing, then, during a second step, the temperature is increased in order to promote the conversion of the molybdenum carboxylate into molybdenum sulfide.

The molybdenum carboxylate may be used in any process for hydroconversion of a heavy fraction. Generally, the hydroconversion is carried out at high temperature, typically between 320° C. and 500° C., preferentially between 350° C. and 450° C. The hydrogen partial pressure is high, typically between 30 bar and 300 bar, preferentially between 50 bar and 200 bar.

The content of molybdenum in the feedstock to be treated is to be adapted depending on the desired performance properties, the operating conditions and especially depending on the nature of the feedstock to be treated. By way of indication, the content by weight of molybdenum may be between 10 ppm and 30000 ppm, preferably between 100 ppm and 5000 ppm, this content being expressed as ppm of metal molybdenum relative to the weight of the feedstock to be treated present in the reactor.

The molybdenum carboxylate according to the invention may be prepared by reacting molybdic acid or an ammonium molybdate and the corresponding carboxylic acid, then in separating the insoluble matter so as to recover the carboxylate. In the case of molybdenum neodecanoate, the carboxylic acid is generally a mixture of carboxylic acid(s) of formula (I):

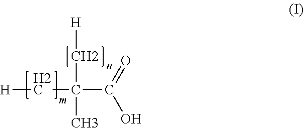

wherein n and m represent integers for which n+m equals 7.

The ammonium molybdate may for example be ammonium dimolybdate or heptamolybdate. The reaction requires heating the mixture and eliminating the water which is formed. The mixture is generally heated to a temperature of between 200° C. and 250° C. The water which is formed during the reaction is eliminated to shift the equilibrium. On the laboratory scale, the water may be eliminated using a round-bottomed flask fitted with a Dean-Stark apparatus. The reaction duration is variable and generally varies between 5 h and 100 h depending on the nature of the acid and on the desired yield. The acid and the molybdic acid are generally employed in stoichiometric proportions so as to react all the acid. In the case of an incomplete reaction, the product recovered is a mixture of the carboxylate, the starting carboxylic acid and the molybdic acid or the starting molybdate that has not completely reacted. After filtration, a mixture of the carboxylate and the starting carboxylic acid may be recovered.

The molybdenum carboxylate may be used pure or in a mixture with the starting carboxylic acid that has not completely reacted. It is also possible to use a solution of the molybdenum carboxylate in an organic solvent, the carboxylate optionally being mixed with the starting carboxylic acid that has not completely reacted.

### EXAMPLES

### Example 1

### Molybdenum Neodecanoate

129.3 g of neodecanoic acid and 31.8 g of molybdic acid (MoO₃ content >85%) are mixed in a 500 ml three-necked round-bottomed flask provided with a thermometer and a Dean-Stark apparatus fitted with a reflux condenser. The round-bottomed flask is then placed under magnetic stirring and heated using an electrical heating mantle. The mixture is heated to 237° C. under inert atmosphere under nitrogen for 30 h. After filtration, the insoluble substances are separated off and a solution of molybdenum neodecanoate containing 12.5% by weight of molybdenum is obtained.

### Example 2

### Molybdenum Neodecanoate

122.1 g of neodecanoic acid and 30.0 g of molybdic acid (MoO₃ content >85%) are mixed in a 500 ml three-necked round-bottomed flask provided with a thermometer and a Dean-Stark apparatus fitted with a reflux condenser. The round-bottomed flask is then placed under magnetic stirring and heated using an electrical heating mantle. The mixture is heated to 200° C. under inert atmosphere under nitrogen for 82 h. After filtration, the insoluble substances are separated off and a solution containing 11.4% by weight of molybdenum is obtained.

### Example 3

### Molybdenum Nonanoate

115.6 g of nonanoic acid (purity >97% by weight) and 30.0 g of molybdic acid (MoO₃ content >85%) are mixed in a 500 ml three-necked round-bottomed flask provided with a thermometer and a Dean-Stark apparatus fitted with a reflux condenser. The round-bottomed flask is then placed under magnetic stirring and heated using an electrical heating mantle. The mixture is heated to 237° C. under inert atmosphere under nitrogen for 21 h. The insoluble substances are separated off and a solution, the Mo content of which is estimated at 12.6% by weight of molybdenum, is obtained.

### Example 4

### Molybdenum Iso-Octadecanoate

206.8 g of iso-octadecanoic acid (purity >97.5% by weight) and 30.0 g of molybdic acid (MoO₃ content >85%) are mixed in a 500 ml three-necked round-bottomed flask provided with a thermometer and a Dean-Stark apparatus fitted with a reflux condenser. The round-bottomed flask is then placed under magnetic stirring and heated using an electrical heating mantle. The mixture is heated to 200° C. under inert atmosphere under nitrogen for 7.5 h. After filtration, the insoluble substances are separated off and a solution containing 1.4% by weight of molybdenum is obtained.

1-17. (canceled)

18. A process for preparing a catalyst based on molybdenum sulfide, the process comprising converting at least one molybdenum carboxylate into molybdenum sulfide; wherein the molybdenum carboxylate is selected from the group consisting of molybdenum neodecanoate, molybdenum nonanoate, molybdenum 3,5,5-trimethylhexanoate and molybdenum iso-octadecanoate.

19. The process of claim 18, wherein the catalyst based on molybdenum sulfide is used in a hydroconversion process.

20. The process of claim 19, wherein the hydroconversion process is a process for the hydroconversion of a heavy feedstock.

21. The process of claim 18, wherein the catalyst based on molybdenum sulfide is prepared in situ in a hydroconversion reactor.

22. The process of claim 18, wherein the catalyst based on molybdenum sulfide is in the form of nanoparticles of MoS₂.

23. The process of claim 22, wherein the nanoparticles of MoS₂ are in the form of sheets.

24. The process of claim 22, wherein the nanoparticles of MoS₂ are suspended in a hydroconversion reactor or dispersed at the surface of carbon-based particles present in a hydroconversion reactor.

25. The process of claim 18, further comprising combining the molybdenum sulfide with a cracking catalyst which is in the form of micrometric or nanoscale particles.

26. The process of claim 25, wherein nanoparticles of molybdenum sulfide are dispersed at the surface of the particles of the cracking catalyst.

27. The process of claim 18, wherein the catalyst based on molybdenum sulfide is composed of particles of a mineral material, on which a layer of molybdenum sulfide is partially or completely deposited.

28. The process of claim 27, wherein the mineral material is preferably in the form of beads, granules or extrudates.

29. The process of claim 18, wherein converting at least one molybdenum carboxylate into molybdenum sulfide is carried out in the presence of at least one sulfurizing agent and hydrogen.

30. The process of claim 29, wherein converting at least one molybdenum carboxylate into molybdenum sulfide occurs in situ in a hydroconversion reactor.

31. The process of claim 29, wherein the catalyst based on molybdenum sulfide is in the form of nanoparticles of MoS₂, either in the form of sheets, suspended in the hydroconversion reactor, or dispersed at the surface of carbon-based particles present in the hydroconversion reactor.

32. The process of claim 29, further comprising combining the molybdenum sulfide with a cracking catalyst which is in the form of micrometric or nanoscale particles, wherein nanoparticles of molybdenum sulfide are dispersed at the surface of the particles of the cracking catalyst.

33. The process of claim 29, wherein the catalyst based on molybdenum sulfide is composed of particles of a mineral material, on which a layer of molybdenum sulfide is partially or completely deposited.

34. A molybdenum carboxylate selected from the group consisting of molybdenum nonanoate, 3,5,5-trimethylhexanoate and iso-octadecanoate.

35. A solution comprising the molybdenum carboxylate of claim 34 dissolved in an organic solvent, wherein the carboxylate is optionally mixed with the corresponding carboxylic acid.

36. A process for preparing a carboxylate as claimed in claim 34, the process consisting of reacting molybdic acid or an ammonium molybdate and the corresponding carboxylic acid, and separating the insoluble matter so as to recover the carboxylate.

37. A process for preparing the solution of carboxylate as claimed in claim 35, the process consisting of reacting molybdic acid or an ammonium molybdate and the corresponding carboxylic acid, and separating the insoluble matter so as to recover the solution of carboxylate.
